(19) United States
(12) Patent Application Publication
(10) Pub. No.: US 2007/0061194 A1
(43) Pub. Date: Mar. 15, 2007

(54) Device and method for generating commercial-containing music data and commercial-containing music data

(76) Inventors: Yasuhiro Kikuchi, Tokyo (JP); Masahiko Okuno, Tokyo (JP)

Correspondence Address: Yasuhiro Kikuchi, 906 Wisteria heights Ichibancho,, 8-banchi, Ichibancho, Chiyoda-ku, 102-0085, JP

(21) Appl. No.: 11/223,489

(22) Filed: Sep. 12, 2005

(51) Int. Cl. G06Q 30/00

(52) U.S. Cl. 705/14

(57) ABSTRACT

Problem to be Solved: The object of the present invention is to enable music distribution implemented over the Internet to provide music less expensively than in the past or free of charge. Solution: The present invention provides commercial-containing music data comprised of inserting commercial data before and/or after music data. Since commercial data is heard by a user as a result of the commercial data being played back whenever music data is played back, a portion of all of the fees for playing back music data can be covered thereby.

### BACKGROUND OF THE INVENTION AND RELATED ART STATEMENT

The present invention relates to commercial-containing music data that enables music to be provided either less expensively than in the past or free of charge.

Music has conventionally been provided recorded on recording media such as records, cassette tapes, compact discs (CD) or mini discs (MD). At present, the purchasing of music data in the form of downloading directly to a personal computer is becoming increasingly popular to the proliferation of the Internet. In addition, music data has also begun to be downloaded with cell phones.

Japanese Unexamined Patent Publication No. 2004-354746 serves as a reference with respect to the downloading and playing of music data. In this music distribution system, during the playback of music data stored in one buffer, the next music data is downloaded and stored in another buffer, and once the playing of music data of one buffer is completed, together with the playback of music data of the other buffer starting, the next music data is downloaded to the buffer for which playback has been completed. In this manner, music data can be alternately read from these buffers enabling music data to be played back without interruption.

However, it is apparent that the high cost of purchasing music data is likely to limit the use of this service. Although this music distribution system relates to the continuous playback of music data, a similar problem of placing a considerable monetary burden on users results in the case of downloading a large amount of music data even if it is not played back continuously.

In order to expand the music distribution business by actively downloading music data, this problem of the burden placed on users must be solved. Thus, an object of the present invention is to enable music distribution implemented over the Internet to provide music less expensively than in the past or free of charge.

### SUMMARY OF THE INVENTION

The aforementioned object is achieved by allowing commercial data to be inserted before and/or after music data. Namely, the present invention provides a device for generating commercial-containing music data comprising: a storage device that stores music data and commercial data, and an editing device that inserts commercial data before and/or after music data by reading the data from the storage device. As a result, commercial data is always played back and heard by users whenever music data is played back. Consequently, a portion or all of the cost of playing back music data is covered. Furthermore, the aforementioned commercial data can also be in the form of audio data. Music data and commercial data are played back using an audio playback device. In addition, the aforementioned commercial data can also be in the form of video data. Commercial data is then played back using a video playback device. Furthermore, a video playback device is typically composed so as to also be able to play back audio data only. This type of commercial-containing music data is completely new, and is extremely effective in reducing the burden of usage fees on users.

Furthermore, the commercial-containing music data of the present invention is typically provided to users by downloading or streaming over the Internet. In addition, it can also be provided to users by being transmitted with television or other broadcast waves. In addition, the commercial-containing music data of the present invention can also be provided to playback devices provided in user car navigation systems by transmitting with radio multiplexed broadcasts or beacons using traffic information communication networks. In addition, it can also be distributed by CD-ROM or other recording media. Thus, there are no limitations whatsoever on the distribution form of the commercial-containing music data of the present invention.

Next, lifetime data can also be inserted into the commercial-containing music data. Lifetime data refers to data for placing limitations on this music data such as the number of times the music data can be played by counting the number of times the music data is played and preventing it from being played back further once the lifetime of the music data has elapsed. Although the characteristic of the commercial-containing music data of the present invention is precisely the containing of commercials, since commercials should be distributed in a systematic manner, there are times when commercials can present problems if they are allowed to be distributed continuously. For example, if files are exchanged by file exchange software using a peer to peer (P2P) system, commercial-containing music data may continue to exist indefinitely on the Internet. If lifetime data is inserted in such cases, the commercial data no longer exists once it has been played a predetermined number of times. This lifetime data is also effective in cases of desiring to limit the playback of music data itself. Furthermore, TTL (Time to Live) and other technologies used in Internet packets also serve as a reference. Alternatively, lifetime software can also be inserted in commercial-containing music data. A function that monitors the lifetime of this data should then be given to the aforementioned audio playback device or video playback device.

In the present invention, commercial-containing music data is able to be generated by ranking music data having the largest number of downloads based on a download record of commercial-containing music data together with ranking commercial data to sequentially assign commercial data starting with that having the highest rank from music data having the highest rank. As a result, for example, commercial data that allows the acquisition of large sponsor fees can be assigned to music data having the highest number of downloads. This is an optimum business model for increasing the earnings of distributors (namely, for providing music to users either less expensively than in the past or free of charge. Here, the combinations of music data and commercial data are not fixed, but rather it is particularly important that music data and commercial data can be recombined based on a download record.

Furthermore, single units of commercial-containing music data of the present invention can also be provided in the form of continuously coupled multiple units. In addition, these multiple units may also be arranged based on some form of play list.

### BRIEF DESCRIPTION OF THE DRAWINGS

FIG. 1 is a block drawing of a generation device of a first embodiment.

FIG. 2 is a flow chart representing a method for generating commercial-containing music data.

FIG. 3 is an explanatory drawing representing a distribution state.

FIG. 4 is an explanatory drawing of commercial-containing music data.

FIG. 5 is a flow chart during playback.

FIG. 6 is a block drawing of a generation device of a second embodiment.

FIG. 7 is an explanatory drawing of commercial-containing music data of a third embodiment.

FIG. 8 is a flow chart during playback.

FIG. 9 is an explanatory drawing of commercial-containing music data of a fourth embodiment.

FIG. 10 is a flow chart representing a method for generating commercial-containing music data.

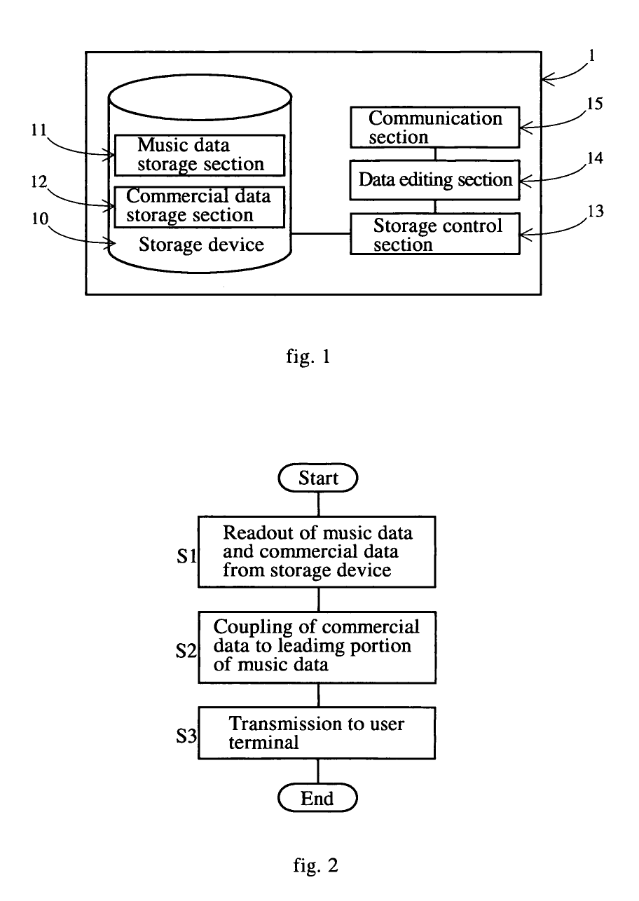

### DETAILED DESCRIPTION OF THE PREFERRED EMBODIMENTS

### First Embodiment

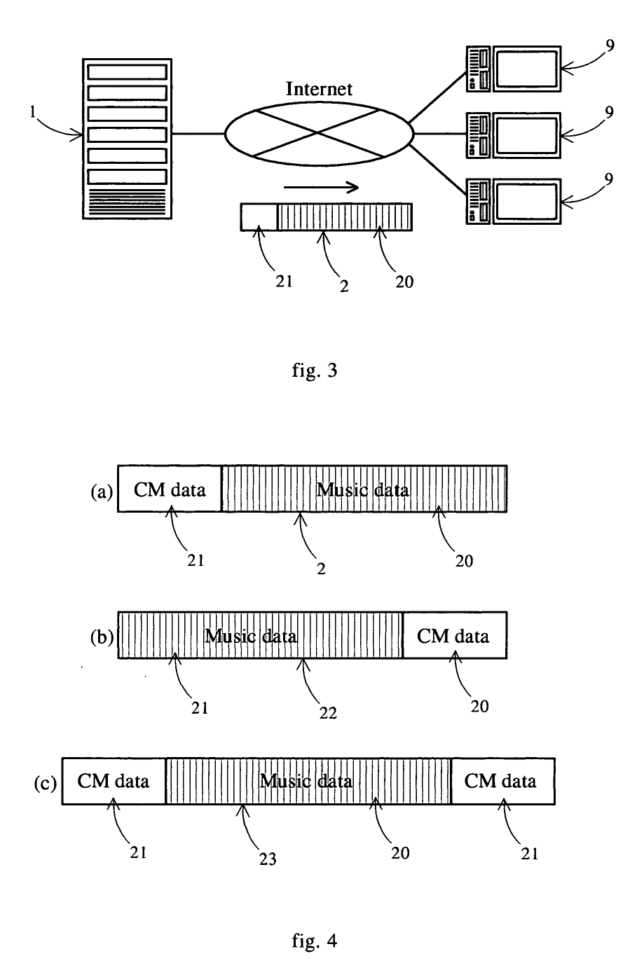

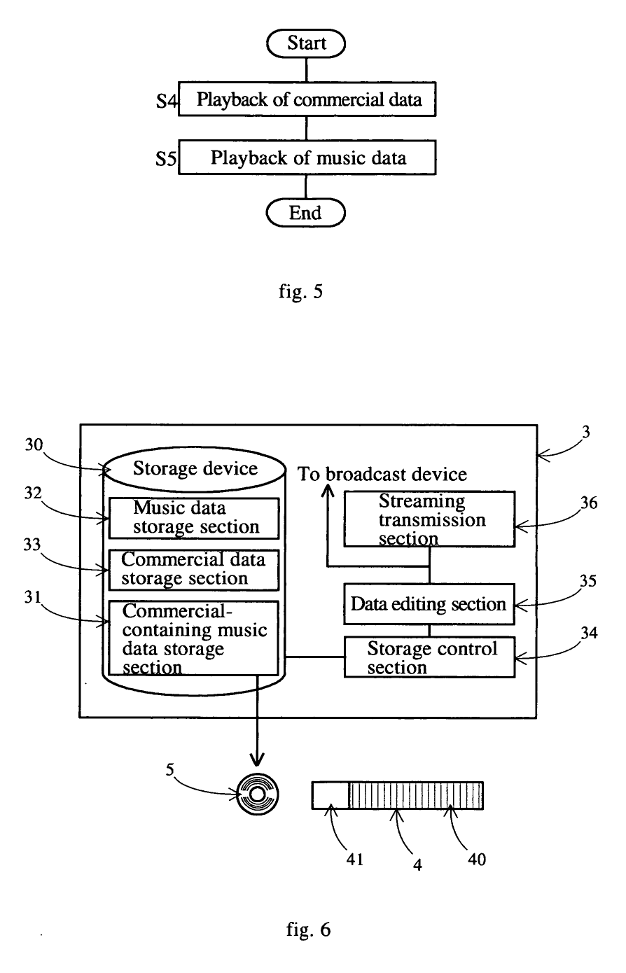

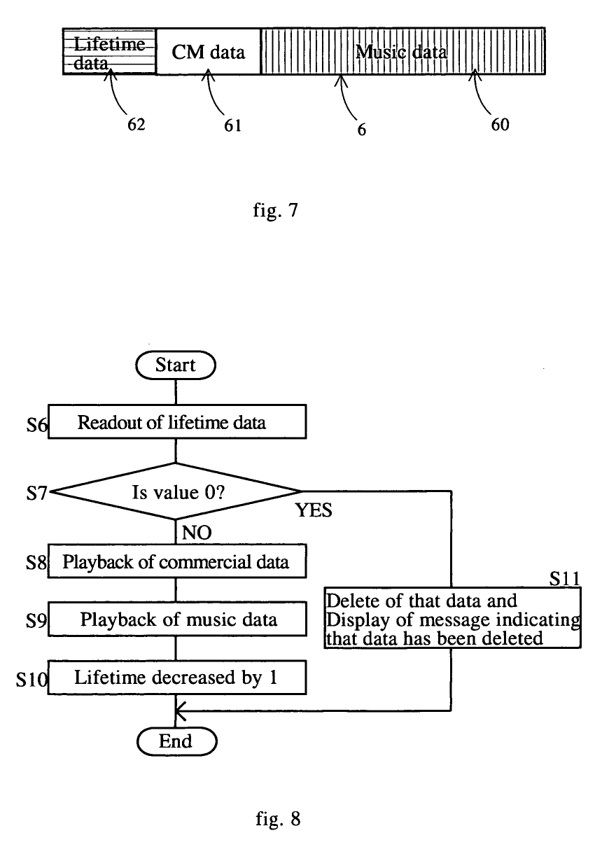

A generation device 1 is composed of a storage device 10 in which storage areas are secured for a music data storage section 11 and a commercial data storage section 12, a storage control section 13 that stores or updates music data 20 and commercial data 21 to this storage device 10, a data editing section 14 that reads music data 20 and commercial data 21 from storage device 10 and couples both data according to this storage control section 13, and a communication section 15 that transmits commercial-containing music data 2 generated in this manner to a user terminal 9 in response to a request from that user terminal 9. Namely, a step (S1), in which music data 20 is read from music data storage section 11 of storage device 10 and commercial data 21 is read from commercial data storage section 12, a step (S2), in which commercial data 21 is coupled to the leading portion of music data 20 for the music data 20 and commercial data 21 read in this manner, and a step (S3), in which the resulting commercial-containing music data 2 is transmitted to a user terminal 9, are executed. As a result, generation device 1 transmits commercial-containing music data 2 represented in FIG. 4(a) to a user terminal 9 over the Internet as represented in FIG. 3.

This commercial-containing music data 2 is played by being received by user terminal 9. A step (S4), in which the leading portion of commercial data 21 is played back, and a step (S5), in which subsequent music data 20 is played back, are sequentially executed in user terminal 9. Thus, a user listens to a commercial prior to listening to the desired music.

Furthermore, in generation device 1, in addition to commercial-containing music data 2 in which commercial data 21 is coupled to the leading portion of music data 20 represented in FIG. 4(a), generation device 1 is also composed so as to be able to generate commercial-containing music data 22 in which commercial data 21 is coupled to the end portion of music data 20 as shown in FIG. 4(b) as well as commercial-containing music data 23 in which commercial data 21 is coupled to leading portion and end portion of music data 20 as shown in FIG. 4(c).

### Second Embodiment

A generation device 6 is composed of a storage device 30 in which storage areas are secured for a music data storage section 32, a commercial data storage section 33 and a commercial-containing music data storage section 31, a storage control section 34 that stores or updates music data 40 and commercial data 41 to this storage device 30, a data editing section 35 that reads music data 40 and commercial data 41 from storage device 30 and couples both data according to this storage control section 34, and a streaming transmission section 36 in which commercial-containing music data 4 generated in this manner is temporarily contained in commercial-containing music data storage section 31, but is transmitted by streaming to a user terminal in response to a request from that user terminal.

In addition, commercial-containing music data 4 is sent to a broadcast device not shown as necessary and transmitted to a television receiver of a user in the form a data broadcast during a multiplexed broadcast. In addition, commercial-containing music data 4 contained in commercial-containing music data storage section 31 is copied to a CD-ROM 5 by storage control section 34 as necessary. Thus, commercial-containing music data 4 of the present invention can also be used in the form of, for example, a magazine supplement.

### Third Embodiment

Commercial data 61 is coupled in front of music data 60, and lifetime data 62 is additionally coupled in front of this commercial data 61. Although a integral value of 10, for example, is set as the initial value of this lifetime data 62, the part of this lifetime data 62 can be rewritten as indicated below by a playback device not shown. Furthermore, this commercial data 61 is a video with sound.

Although this commercial-containing music data 6 is played by being received by a user terminal not shown, a step (S6) is first executed in which this lifetime data 62 is read, after which this value is investigated in a step (S7), and if the value is not 0, a step (S8), in which commercial data 21 following lifetime data 62 is played back, and a step (S9), in which the next music data 20 is played back, are sequentially executed. Once this playback is completed, although a step (S10) is executed in which the value of lifetime data 62 decreases by 1, if the value in S7 is 0, a step (S11) is executed in which this commercial-containing music data 6 is deleted and a message to that effect is displayed. Furthermore, if the result of having executed step (S10) in which the value of lifetime data 62 is decreased by 1 is 0, a value of 0 is assessed in step (S7) the next time it is executed and step (S11) is executed.

### Fourth Embodiment

A generation device not shown generates a download ranking list 70 of commercial-containing music data from the results of previous downloads. The ranking of commercial-containing music data can be said, in other words, to be a music ranking since a user primarily downloads music that he or she likes. On the other hand, a fee ranking list that corresponds to the size of advertising fees paid by sponsors is also generated. Ranking table 7 is thus generated composed of this music data download ranking 70 and fee ranking 71.

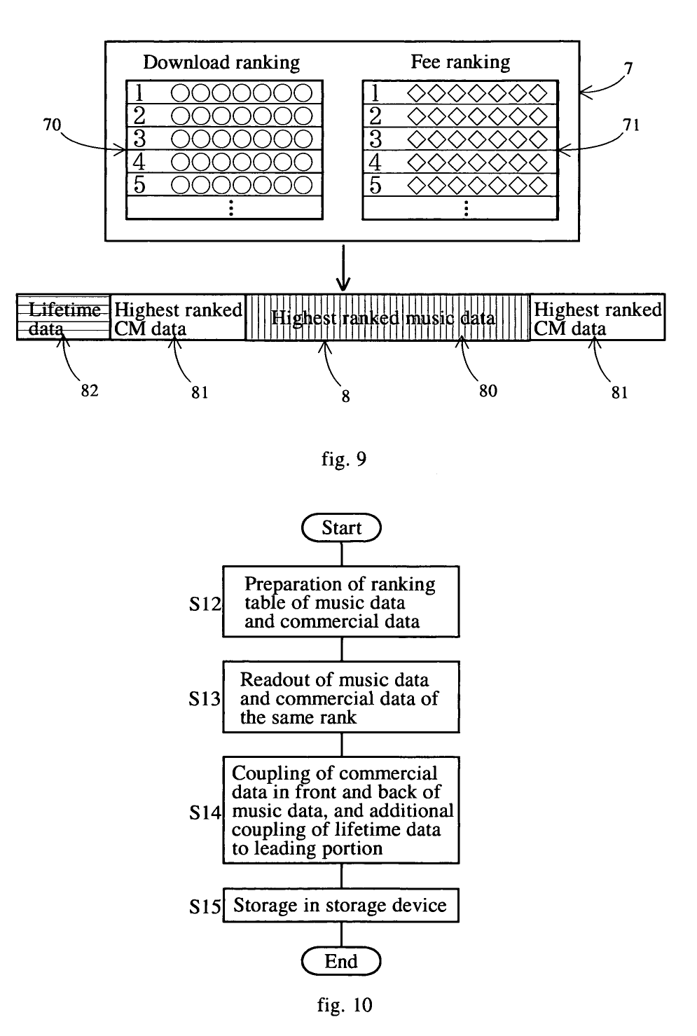

A generating device not shown that is based on this ranking table 7 combines the music data having the highest download ranking and the commercial data having the highest fee ranking, and continues to generate combinations based on rankings to generate commercial-containing music data shown in FIG. 9 on the basis of this. This commercial-containing music data 8 relates to that having the highest ranking, the highest ranked commercial data 81 is coupled before and after the highest ranked music data 80, and lifetime data 82 is coupled before the highest ranked commercial data 81 coupled in front of commercial-containing music data 8. Furthermore, combinations of the second highest rank data and beyond are generated in the same manner.

In the case of this commercial-containing music data, a step (S12), in which the aforementioned ranking table 7 is prepared, a step (S13), in which music data 80 and commercial data 81 are read in the same order based on the aforementioned ranking table 7 from a music data storage section and commercial data storage section, respectively, of a storage device not shown, a step (S14), in which commercial data 81 is coupled before and after music data 80, and lifetime data 82 is coupled to its leading portion, and a step (S15), in which the resulting commercial-containing music data 8 is recorded in the commercial-containing music data storage section of a storage device not shown, are executed. Furthermore, in ranking table 7, although this also true of fee ranking 71, since download ranking 70 in particular changes by the moment, it is preferable that the aforementioned combination processing of music data 80 and commercial data 81 having the same rankings be carried out periodically. In addition, the rules for combining data are not only be based on fee ranking 71 corresponding to the size of advertising fees, but rather may also employ any arbitrary parameter such as that referring to ranking according to the magnitude of advertising frequency. A single piece of commercial data may also be combined with two or more pieces of music data.

Although the above has provided explanations of various embodiments, since the present invention makes it possible to cover all or a portion of the fees for playing back music data using advertising fees from sponsors, users are able to be provided with music either less expensively than in the past or free of charge, thereby demonstrating the usefulness of the present invention.

The reason for inserting lifetime data in this commercial-containing music data is to be able to provide an expiration date on the distribution of commercial data. In addition, by changing the combinations of music data and commercial data according to the number of times music data is downloaded, there is the additional effect of being able to insert commercial data having a high advertising fee into the most popular music data.

Moreover, the present invention has the following industrial applicability. Namely, the present invention is not limited to music data, but can also be applied to a wide range of other data including video data, cartoon data and publication data. It is particularly important that it is possible to change the combinations of this data and commercial data based on rankings or provide a lifetime for the commercial data, thus giving the present invention a high degree of industrial applicability.

What is claimed is:

1. A device for generating commercial-containing music data comprising: a storage device that stores music data and commercial data, and an editing device that inserts commercial data before and/or after music data by reading the data from the storage device.

2. A device for generating commercial-containing music data according to claim 1 wherein the editing device inserts lifetime data.

3. A device for generating commercial-containing music data according to claim 1 wherein the editing device ranks music data having the largest number of downloads based on a download record of commercial-containing music data together with ranking commercial data to sequentially assign commercial data starting with that having the highest rank from music data having the highest rank.

4. A method for generating commercial-containing music data comprising reading music data and commercial data from a storage device and inserting the commercial data before and/or after the music data.

5. A method for generating commercial-containing music data according to claim 4 that additionally inserts lifetime data.

6. A method for generating commercial-containing music data according to claim 4 wherein music data having the largest number of downloads is ranked based on a download record of commercial-containing music data together with ranking commercial data to sequentially assign commercial data starting with that having the highest rank from music data having the highest rank.

7. Commercial-containing music data comprised by inserting commercial data before and/or after music data.

8. Commercial-containing music data according to claim 7 in which lifetime data is additionally inserted.
